(19) United States
(12) Patent Application Publication
(10) Pub. No.: US 2016/0362575 A1
(43) Pub. Date: Dec. 15, 2016

(54) INORGANIC PARTICULATE SUSPENSION HAVING IMPROVED HIGH SHEAR VISCOSITY

(71) Applicant: IMERYS USA, INC., Roswell, GA (US)

(72) Inventors: Anthony V. LYONS, Macon, GA (US); Roger WYGANT, East Dublin, GA (US); Daniel J. PANFIL, Milledgeville, GA (US); Christ BOOTHBY, Suwanee, GA (US); Phil JONES, Woodstock, GA (US)

(21) Appl. No.: 15/121,639

(22) PCT Filed: Feb. 25, 2015
(86) PCT No.: PCT/US15/17446

§ 371 Date: Aug. 25, 2016

Related U.S. Application Data
(60) Provisional application No. 61/944,973, filed on Feb. 26, 2014.

(51) Int. Cl. C09D 17/00; C09D 7/12; D21H 19/40; C09D 1/00

(52) U.S. Cl. CPC C09D 17/004; C09D 1/00; C09D 7/1291; C09D 7/1283; D21H 19/40

(57) ABSTRACT

An inorganic particulate suspension may include a first kaolin having a shape factor of at least about 70, and a second kaolin having a shape factor less than or equal to about 20. The first kaolin and the second kaolin form a kaolin composition, which may have a content ratio of the first kaolin to the second kaolin ranging from about 90:10 to about 50:50. An inorganic particulate suspension may include a kaolin composition having a shape factor ranging from about 55 to about 75, wherein at least about 70% to about 90% by weight of the particles of the kaolin composition have an equivalent spherical diameter less than 2 microns. The suspension may have a Hercules viscosity ranging from about 600 rpm to about 700 rpm at 18.0 dyne using an “A” bob, and the suspension may have a solids content ranging from about 55% to about 75% solids.

### CLAIMS OF PRIORITY

This PCT International Application claims the benefit of priority of U.S. Provisional Application No. 61/944,973, filed Feb. 26, 2014, the subject matter of which is incorporated herein by reference in its entirety.

### DESCRIPTION

### Field of the Disclosure

The present disclosure relates to inorganic particulate suspensions, and more particularly, to inorganic particulate suspensions having improved high shear viscosity for use in coating compositions.

### Background

Particulate kaolin products find a variety of uses such as, for example, use as pigments, fillers, and extenders for use in paint, plastics, polymers, paper making, and paper coating. Kaolin clay, also referred to as China Clay, or hydrous kaolin, consists predominantly of the mineral kaolinite and hydrous aluminum silicate, together with small amounts of a variety of impurities.

Particulate kaolins generally exist in three forms: hydrous kaolin, calcined kaolin, and chemically-aggregated kaolin. Hydrous kaolin is primarily the mineral kaolinite, which has been obtained from natural sources. Calcined kaolins are obtained by processing hydrous kaolins at high temperatures, for example, temperatures greater than 800° C. Chemically-aggregated kaolins are composites having a micro-structure resembling that of calcined kaolins produced by treating hydrous kaolins with chemicals. Calcined and chemically-aggregated kaolins can show benefits in certain application compositions when compared with hydrous kaolins. However, the benefits associated with calcined and chemically-aggregated kaolins are not without disadvantages. The cost of production of calcined and chemically-aggregated kaolins are significantly above those of hydrous kaolins. The calcined and chemically-aggregated kaolins also have the effect of improving certain paper properties while adversely effecting other properties, such as strength.

Kaolin has been used as an extender or pigment in paints, plastics, and paper coating compositions. Calcined kaolin pigments confer desirable physical and optical properties to such compositions. As flattening (or matting) agents, they help smooth the surfaces to the substrates to which they are applied. As opacifiers, they impart brightness, whiteness, gloss, and other desirable optical properties. As extenders, they may allow partial replacement of titanium dioxide and other more expensive pigments with minimal loss of whiteness or brightness.

Paper coatings are applied to sheet materials for a number of purposes, including, but not limited to, increasing the gloss, smoothness, opacity, and/or brightness of the material. Coatings may also be applied to hide surface irregularities or in other ways improve the surface for the acceptance of print. Paper coatings are generally prepared by forming a fluid aqueous suspension of pigment material together with a hydrophilic adhesive and other optional ingredients.

Coatings have been conventionally applied by means of a coating machine including a short dwell time coating head, which is a device in which a captive pond of coating composition under a slightly elevated pressure is held in contact with a moving paper web for a time sufficient to coat the paper before excess coating composition is removed by a trailing blade.

Generally, kaolins for use in paper coatings and fillers may be selected to provide a favored set of physical and optical properties, for example, maximum light scatter.

For example, hyperplaty kaolin (e.g., kaolin having a shape factor of at least about 70) may be used in such coatings, and may generally provide the coating with improved quality and printability of the coated substrate. However, hyperplaty kaolin may increase the high shear viscosity of the coating, which, in turn, may result in application of the coating being undesirably difficult. In addition, a high shear viscosity may result in a reduced solids content in the coating composition, thereby reducing the filling effect of the kaolin. Therefore, it may be desirable to provide a coating composition having a reduced high shear viscosity to achieve improved coating application for coating paper, paperboards, and packaging. In addition, it may be desirable to provide a coating composition having a reduced high shear viscosity to enable an increase in the solids content of the coating composition.

### SUMMARY

In accordance with a first aspect, an inorganic particulate suspension may include a first kaolin having a shape factor of at least about 70, and a second kaolin having a shape factor less than or equal to about 20. The first kaolin and the second kaolin form a kaolin composition, and the kaolin composition may have a content ratio of the first kaolin to the second kaolin ranging from about 90:10 to about 50:50. For example, the kaolin composition may have a shape factor ranging from about 55 to about 75, from about 60 to about 75, or from about 63 to about 70. According to some aspects, the inorganic particulate suspension may have a content ratio of the first kaolin to the second kaolin ranging from about 85:15 to about 60:40, or from about from about 80:20 to about 70:30.

As used herein, “shape factor” is a measure of an average value (on a weight average basis) of the ratio of mean particle diameter to particle thickness for a population of particles of varying size and shape, as measured using the electrical conductivity method and apparatus described in, for example, U.S. Pat. No. 5,128,606, and using the equations derived in its specification. “Mean particle diameter” is defined as the diameter of a circle that has the same area as the largest face of the particle. The electrical conductivity of a fully-dispersed aqueous suspension of the particles under test is caused to flow through an elongated tube. Measurements of the electrical conductivity are taken between (a) a pair of electrodes separated from one another along the longitudinal axis of the tube, and (b) a pair of electrodes separated from one another across the transverse width of the tube. Using the difference between the two conductivity measurements, the shape factor of the particulate material under test may be determined.

According to another aspect, at least about 70% to about 90% by weight of the particles of the kaolin composition may have an equivalent spherical diameter less than 2 microns. For example, at least about 75% to about 85% by weight of the particles of the kaolin composition may have an equivalent spherical diameter less than 2 microns. According to a further aspect, at least about 20% to about 40% by weight of the particles of the kaolin composition may have an equivalent spherical diameter less than 0.25 microns, for example, at least about 25% to about 35% by weight of the particles of the kaolin composition may have an equivalent spherical diameter less than 0.25 microns.

“Particle size,” as used herein, for example, in the context of particle size distribution (psd), may be measured in terms of equivalent spherical diameter (esd). Particle size properties referred to in the present disclosure may be measured in a well-known manner, for example, by sedimentation of the particulate material in a fully-dispersed condition in an aqueous medium using a SEDIGRAPH 5100™ machine, as supplied by Micromeritics Corporation. Such a machine may provide measurements and a plot of the cumulative percentage by weight of particles having a size, referred to in the art as “equivalent spherical diameter” (esd), less than the given esd values. For example, the mean particle size d₅₀ is the value that may be determined in this way of the particle esd at which there are 50% by weight of the particles that have an esd less than that d₅₀ value.

According to yet another aspect, the inorganic particulate suspension may have a solids content ranging from about 55% to about 75% solids. For example, the inorganic particulate suspension may have a solids content ranging from about 60% to about 75% solids, from about 65% to about 75% solids, or from about 65% to about 70% solids.

According to a further aspect, the inorganic particulate suspension may have a Hercules viscosity ranging from about 600 rpm to about 700 rpm at 18.0 dyne using an “A” bob. For example, the inorganic particulate suspension may have a Hercules viscosity ranging from about 610 rpm to about 690 rpm at 18.0 dyne using an “A” bob, or from about 620 rpm to about 685 rpm at 18.0 dyne using an “A” bob.

According to a further aspect, the inorganic particulate suspension may have a Brookfield viscosity ranging from about 280 cps to about 580 cps using a #2 spindle at 20 rpm. For example, the inorganic particulate suspension may have a Brookfield viscosity ranging from about 300 cps to about 550 cps using a #2 spindle at 20 rpm, from about 350 cps to about 550 cps using a #2 spindle at 20 rpm, from about 500 cps to about 550 cps using a #2 spindle at 20 rpm.

According to still a further aspect, the first kaolin may have a shape factor of greater than about 75. According to yet a further aspect, the first kaolin may have an average plate diameter ranging from about 2 to about 15 microns. The average plate diameter may be determined by the Jennings equation, which equals the median particle size (d₅₀) multiplied by the square-root of the result of 2.356 divided by the shape factor (SF), or

average plate diameter=d₅₀×(2.356/SF)^{1/2}.

According to yet another aspect, at least about 65% to about 85% by weight of the particles of the first kaolin may have an equivalent spherical diameter less than 2 microns. According to still another aspect, at least about 15% to about 30% by weight of the particles of the first kaolin may have an equivalent spherical diameter less than 0.25 microns.

According to another aspect, the second kaolin may have a shape factor of less than or equal to about 15. According to a further aspect, at least about 95% by weight of the particles of the second kaolin may have an equivalent spherical diameter less than 2 microns. In another aspect, at least about 50% to about 65% by weight of the particles of the second kaolin may have an equivalent spherical diameter less than 0.25 microns.

According to still a further aspect, an inorganic particulate suspension may include a kaolin composition having a shape factor ranging from about 55 to about 75, wherein at least about 70% to about 90% by weight of the particles of the kaolin composition have an equivalent spherical diameter less than 2 microns. The inorganic particulate suspension may have a Hercules viscosity ranging from about 600 rpm to about 700 rpm at 18.0 dyne using an “A” bob, and the inorganic particulate suspension may have a solids content ranging from about 55% to about 75% solids.

According to another aspect, the kaolin composition may have a shape factor ranging from about 60 to about 75, or from about 63 to about 70.

According to a further aspect, at least about 75% to about 85% by weight of the particles of the kaolin composition may have an equivalent spherical diameter less than 2 microns. According to yet another aspect, at least about 20% to about 40% by weight of the particles of the kaolin composition may have an equivalent spherical diameter less than 0.25 microns, for example, at least about 25% to about 35% by weight of the particles of the kaolin composition may have an equivalent spherical diameter less than 0.25 microns.

According to a further aspect, the inorganic particulate suspension may have a solids content ranging from about 60% to about 75% solids. For example, the inorganic particulate suspension may have a solids content ranging from about 65% to about 75% solids, or the inorganic particulate suspension may have a solids content ranging from about 65% to about 70% solids.

According to another aspect, the inorganic particulate suspension may have a Hercules viscosity ranging from about 610 rpm to about 690 rpm at 18.0 dyne using an “A” bob, or from about 620 rpm to about 685 rpm at 18.0 dyne using an “A” bob.

According to yet another aspect, the inorganic particulate suspension may have a Brookfield viscosity ranging from about 300 cps to about 550 cps using a #2 spindle at 20 rpm. For example, the inorganic particulate suspension may have a Brookfield viscosity ranging from about 350 cps to about 550 cps using a #2 spindle at 20 rpm, from about 500 cps to about 550 cps using a #2 spindle at 20 rpm.

It is to be understood that both the foregoing general description and the following detailed description are exemplary and explanatory only and are not restrictive of the invention.

### DESCRIPTION OF EXEMPLARY EMBODIMENTS

Reference will now be made in detail to exemplary embodiments of the invention.

Applicant has surprisingly found that blending a fine blocky kaolin (e.g., a kaolin having a shape factor of less than or equal to about 20 and an esd such that at least about 95% of the particles are less than 2 microns) with a hyperplaty kaolin (e.g., a kaolin having a shape factor of at least about 70) results in a kaolin composition for use in an inorganic particulate suspension for use in coating compositions that decreases the high shear viscosity of the inorganic particulate suspension containing the hyperplaty kaolin composition. In addition, the resulting kaolin composition also permits increase of the slurry solids content. For example, according to some embodiments, the solids content may be increased from about 1% to about 10% (e.g., 2% to about 7%) relative to a pigment slurry containing only the hyperplaty kaolin (i.e., without the fine blocky kaolin) and other non-kaolin solids.

According to some embodiments, an inorganic particulate suspension may include a first kaolin having a shape factor of at least about 70, and a second kaolin having a shape factor less than or equal to about 20. The first kaolin and the second kaolin form a kaolin composition, and the kaolin composition may have a content ratio of the first kaolin to the second kaolin ranging from about 90:10 to about 50:50. For example, the kaolin composition may have a shape factor ranging from about 55 to about 75, from about 60 to about 75, or from about 63 to about 70. According to some embodiments, the inorganic particulate suspension may have a content ratio of the first kaolin to the second kaolin ranging from about 85:15 to about 60:40, or from about from about 80:20 to about 70:30.

As used herein, “shape factor” is a measure of an average value (on a weight average basis) of the ratio of mean particle diameter to particle thickness for a population of particles of varying size and shape, as measured using the electrical conductivity method and apparatus described in, for example, U.S. Pat. No. 5,128,606, and using the equations derived in its specification. “Mean particle diameter” is defined as the diameter of a circle that has the same area as the largest face of the particle. The electrical conductivity of a fully dispersed aqueous suspension of the particles under test is caused to flow through an elongated tube. Measurements of the electrical conductivity are taken between (a) a pair of electrodes separated from one another along the longitudinal axis of the tube, and (b) a pair of electrodes separated from one another across the transverse width of the tube. Using the difference between the two conductivity measurements, the shape factor of the particulate material under test may be determined.

According to some embodiments, at least about 70% to about 90% by weight of the particles of the kaolin composition may have an equivalent spherical diameter less than 2 microns. For example, at least about 75% to about 85% by weight of the particles of the kaolin composition may have an equivalent spherical diameter less than 2 microns. According to some embodiments, at least about 20% to about 40% by weight of the particles of the kaolin composition may have an equivalent spherical diameter less than 0.25 microns, for example, at least about 25% to about 35% by weight of the particles of the kaolin composition may have an equivalent spherical diameter less than 0.25 microns.

According to some embodiments, at least about 95% by weight of the particles of the kaolin composition may have an equivalent spherical diameter less than 10 microns. For example, at least about 97% by weight of the particles of the kaolin composition may have an equivalent spherical diameter less than 10 microns, or at least about 97% by weight of the particles of the kaolin composition may have an equivalent spherical diameter less than 10 microns. According to some embodiments, at least about 94% by weight of the particles of the kaolin composition may have an equivalent spherical diameter less than 5 microns. For example, at least about 95% by weight of the particles of the kaolin composition may have an equivalent spherical diameter less than 5 microns.

According to some embodiments, at least about 55% to about 75% by weight of the particles of the kaolin composition may have an equivalent spherical diameter less than 1 micron. For example, at least about 60% to about 70% by weight of the particles of the kaolin composition may have an equivalent spherical diameter less than 1 micron. According to some embodiments, at least about 40% to about 60% by weight of the particles of the kaolin composition may have an equivalent spherical diameter less than 0.5 microns, for example, at least about 45% to about 55% by weight of the particles of the kaolin composition may have an equivalent spherical diameter less than 0.5 microns.

According to some embodiments, the inorganic particulate suspension may have a solids content ranging from about 55% to about 75% solids. For example, the inorganic particulate suspension may have a solids content ranging from about 60% to about 75% solids, from about 65% to about 75% solids, or from about 65% to about 70% solids.

According to some embodiments, the inorganic particulate suspension may have a Hercules viscosity ranging from about 600 rpm to about 700 rpm at 18.0 dyne using an “A” bob. For example, the inorganic particulate suspension may have a Hercules viscosity ranging from about 610 rpm to about 690 rpm at 18.0 dyne using an “A” bob, or from about 620 rpm to about 685 rpm at 18.0 dyne using an “A” bob.

“Viscosity,” as used herein, is a measure of the rheological properties of a kaolin clay. In particular, viscosity is a measure of resistance of kaolin to changes in flow. Those having ordinary skill in the art are familiar with typical ways of measuring viscosity, which include Hercules viscosity and Brookfield viscosity.

Hercules viscometers provide a measure of a high shear viscosity of an inorganic particulate suspension, for example, a kaolin slurry. Hercules viscosity is typically measured by placing a cylinder (bob) of appropriate diameter and length (typically the A-bob or an E-bob) into a sample slurry. Hercules viscosities of various samples can be compared by holding constant the percent solids concentration of the sample, the bob size, and the applied torque. The Hercules viscometer applies a torque to the bob, which causes it to spin at a controlled acceleration rate. As the viscometer increases the bob spin rate, the viscous drag on the cup increases. Slurries with poor high shear rheology will exert the maximum measurable torque on the cup at a lower bob rpm than slurries with “good” high shear rheology. Hercules viscosity is therefore typically expressed in terms of bob spin rates, or revolutions per minute (rpm). A “dyne endpoint” is an indication of very low Hercules viscosity. A dyne endpoint is reached when the bob reaches its maximum rpm before the maximum measurable torque is exerted on the cup. Sometimes “18.0 dynes” may be used as an abbreviation for 1.8×10̂7 dyne-cm or 18 megadyne-cm.

According to some embodiments, the inorganic particulate suspension may have a Brookfield viscosity ranging from about 280 cps to about 580 cps using a #2 spindle at 20 rpm. For example, the inorganic particulate suspension may have a Brookfield viscosity ranging from about 300 cps to about 550 cps using a #2 spindle at 20 rpm, from about 350 cps to about 550 cps using a #2 spindle at 20 rpm, or from about 500 cps to about 550 cps using a #2 spindle at 20 rpm.

Brookfield viscometers provide a measure of a low shear viscosity of an inorganic particulate suspension, for example, a kaolin slurry, expressed in units of centipoise (cps). One centipoise is equal to one centimeter-gram-second unit. (One centipoise is one one-hundredth (1×10⁻²) of a poise.) Thus, all other things being equal, a 100 centipoise sample has a lower viscosity than a 500 centipoise sample.

According to some embodiments, the first kaolin may have a shape factor of greater than about 75. According to some embodiments, the first kaolin may have an average plate diameter ranging from about 2 to about 15. The average plate diameter may be determined by the Jennings equation, which equals the median particle size (d₅₀) multiplied by the square-root of the result of 2.356 divided by the shape factor (SF), or

average plate diameter=d₅₀×(2.356/SF)^{1/2}.

According to some embodiments, at least about 65% to about 85% by weight of the particles of the first kaolin may have an equivalent spherical diameter less than 2 microns. According to some embodiments, at least about 15% to about 30% by weight of the particles of the first kaolin may have an equivalent spherical diameter less than 0.25 microns.

According to some embodiments, at least about 95% by weight of the particles of the first kaolin may have an equivalent spherical diameter less than 10 microns. For example, at least about 97% by weight of the particles of the first kaolin may have an equivalent spherical diameter less than 10 microns. According to some embodiments, at least about 90% by weight of the particles of the first kaolin may have an equivalent spherical diameter less than 5 microns. For example, at least about 93% by weight of the particles of the first kaolin may have an equivalent spherical diameter less than 5 microns, or at least about 94% by weight of the particles of the first kaolin may have an equivalent spherical diameter less than 5 microns.

According to some embodiments, at least about 50% to about 70% by weight of the particles of the first kaolin may have an equivalent spherical diameter less than 1 micron. According to some embodiments, at least about 55% to about 65% by weight of the particles of the first kaolin may have an equivalent spherical diameter less than 1 micron. According to some embodiments, at least about 35% to about 55% by weight of the particles of the first kaolin may have an equivalent spherical diameter less than 0.5 microns. According to some embodiments, at least about 40% to about 50% by weight of the particles of the first kaolin may have an equivalent spherical diameter less than 0.5 microns.

According to some embodiments, the second kaolin may have a shape factor of less than or equal to about 20. According to some embodiments, at least about 95% by weight of the particles of the second kaolin may have an equivalent spherical diameter less than 2 microns. According to some embodiments, at least about 50% to about 65% by weight of the particles of the second kaolin may have an equivalent spherical diameter less than 0.25 microns.

According to some embodiments, 100% by weight of the particles of the second kaolin may have an equivalent spherical diameter less than 10 microns. According to some embodiments, 100% by weight of the particles of the second kaolin may have an equivalent spherical diameter less than 5 microns. According to some embodiments, at least about 97% by weight of the particles of the second kaolin may have an equivalent spherical diameter less than 2 microns. According to some embodiments, at least about 80% to about 90% by weight of the particles of the second kaolin may have an equivalent spherical diameter less than 0.5 microns.

According to some embodiments, an inorganic particulate suspension may include a kaolin composition having a shape factor ranging from about 55 to about 75, wherein at least about 70% to about 90% by weight of the particles of the kaolin composition have an equivalent spherical diameter less than 2 microns. The inorganic particulate suspension may have a Hercules viscosity ranging from about 600 rpm to about 700 rpm at 18.0 dyne using an “A” bob, and the inorganic particulate suspension may have a solids content ranging from about 55% to about 75% solids.

According to some embodiments, the kaolin composition may have a shape factor ranging from about 60 to about 75, or from about 63 to about 70.

According to some embodiments, at least about 75% to about 85% by weight of the particles of the kaolin composition may have an equivalent spherical diameter less than 2 microns. According to some embodiments, at least about 20% to about 40% by weight of the particles of the kaolin composition may have an equivalent spherical diameter less than 0.25 microns, for example, at least about 25% to about 35% by weight of the particles of the kaolin composition may have an equivalent spherical diameter less than 0.25 microns.

According to some embodiments, the inorganic particulate suspension may have a solids content ranging from about 60% to about 75% solids. For example, the inorganic particulate suspension may have a solids content ranging from about 65% to about 75% solids, or the inorganic particulate suspension may have a solids content ranging from about 65% to about 70% solids.

According to some embodiments, the inorganic particulate suspension may have a Hercules viscosity ranging from about 610 rpm to about 690 rpm at 18.0 dyne using an “A” bob, or from about 620 rpm to about 685 rpm at 18.0 dyne using an “A” bob.

According to some embodiments, the inorganic particulate suspension may have a Brookfield viscosity ranging from about 280 cps to about 580 cps using a #2 spindle at 20 rpm. For example, the inorganic particulate suspension may have a Brookfield viscosity ranging from about 300 cps to about 550 cps using a #2 spindle at 20 rpm, from about 350 cps to about 550 cps using a #2 spindle at 20 rpm, or from about 500 cps to about 550 cps using a #2 spindle at 20 rpm.

According to some embodiments, a coating composition may include an inorganic particulate suspension and a thickener, for example, a thickener present in an amount ranging from about 0.1% to about 0.9% by active dry weight of the composition. For example, the thickener may be selected from at least one of alkali-soluble emulsion polyacrylate thickeners, hydrophobically-modified alkali-soluble emulsion polyacrylate thickeners, and CMC (carboxymethyl celluloses) thickeners.

According to some embodiments, the raw particulate hydrous kaolin may be processed to produce a kaolin pigment according to an exemplary method comprising the steps of: (a) mixing a raw or partially processed kaolin clay with water to form an aqueous kaolin suspension; (b) subjecting the suspension produced by step (a) to attrition grinding using a particulate grinding medium by a process in which the average shape factor of the kaolin clay is increased; (c) separating the suspension of ground kaolin clay from the particulate grinding medium; (d) obtaining a coarse component by classifying, for example, using a centrifuge, and (e) dewatering the suspension of ground coarse kaolin clay separated in step (c) to recover a kaolin pigment therefrom.

When preparing an aqueous suspension of the kaolin clay to be treated in step (a), according to some embodiments, a dispersing agent for the kaolin clay may or may not be added to the kaolin clay.

According to some embodiments, the kaolin clay may be subjected to one or more well-known purification steps to remove undesirable impurities, for example, between steps (a) and (b). For example, the aqueous suspension of kaolin clay may be subjected to a froth flotation treatment operation to remove titanium containing impurities in the froth. Alternatively, or in addition, the suspension may be passed through a high intensity magnetic separator to remove iron containing impurities.

According to some embodiments, step (b) may include a process wherein the suspension of kaolin clay is treated by medium attrition grinding, for example, wherein an energy of from about 40 kWh to about 250 kWh per ton of clay (on a dry weight basis) is dissipated in the suspension. According to some embodiments, step (b) may include a process including at least two stages, for example, a first stage (b1) wherein delamination of the kaolin clay occurs, and a second stage (b2) wherein comminution of the platelets of the kaolin clay occurs.

It has been found that it may be beneficial to subject the suspension of the kaolin clay to a relatively gentle comminution step (b1), for example, grinding using a particulate grinding medium in order to break down composite particles that are present in the raw kaolin clay. Such composite particles may generally include coherent stacks or blocks of individual hexagonal plate-like particles, particularly where the kaolin clay is from a sedimentary deposit. When the kaolin clay is subjected to relatively gentle comminution, for example, by grinding in step (b1), the composite particles are broken down to give the individual thin, substantially hexagonal plates. Such a process may generally be referred to as “delamination,” and has the result of increasing the average shape factor of the kaolin clay. For example, this exemplary process may increase the shape factor of the kaolin clay. As used herein, “relatively gentle grinding” means grinding in an attrition grinding mill with a particulate grinding medium, the contents of the attrition grinding mill being agitated by means of an impeller, which rotates at a speed, which is insufficient to set up a vortex in the suspension, in particular, at a peripheral speed below about 10 meters/second and in which the amount of energy dissipated in the suspension during grinding is less than about 75 kWh per ton, for example, less than about 55 kWh per ton, of kaolin clay on a dry weight basis. The particulate grinding medium may be of relatively high specific gravity, for example, 2 or greater, and may, for example, include grains of silica sand, where the grains generally have diameters not larger than about 2 millimeters and not smaller than about 0.25 mm.

According to some embodiments, stage (b2) of the two stage form of step (b) in the method, the grinding may be performed in an attrition grinding mill, which is equipped with a stirrer capable of being rotated at a speed such that a vortex is formed in the suspension in the mill during grinding. The particulate grinding medium may have a specific gravity of 2 or more, and may include grains of silica sand, wherein the grains may generally having diameters not larger than about 2 mm and not smaller than about 0.25 mm. If stage (b2) is preceded by a relatively gentle comminution in stage (b1), the amount of energy dissipated in the suspension of kaolin clay in stage (b2) may be in the range of from about 40 kWh to about 120 kWh per dry ton of kaolin clay. However, if the relatively gentle comminution step (b1) is omitted, the amount of energy dissipated in the suspension of kaolin clay in step (b) is preferably in the range of from about 100 kWh to about 250 kWh per dry ton of kaolin clay.

According to some embodiments of step (c), the suspension of ground kaolin clay may be separated from the particulate grinding medium in a known manner, for example, by passing the suspension through a sieve of appropriate aperture size, for example, a sieve having nominal aperture sizes in the range of from about 0.1 mm to about 0.25 mm.

According to some embodiments of step (d), the suspension of ground kaolin clay may be classified using a centrifuge (e.g., Alfa Laval or Merco).

Following step (c), step (d) or step (e), according to some embodiments, the kaolin clay may be further treated to improve one or more of its properties. For example high energy liquid working, for example, using a high speed mixer, may be applied to the product in slurry form, for example, before step (e) or after step (e) and subsequent re-dispersion in an aqueous medium, for example, during makedown of a coating composition.

According to some embodiments, in step (e) the suspension of ground kaolin may be dewatered in one of the ways well known in the art, for example, via filtration, centrifugation, evaporation, or the like. For example, use of a filter press may be made to form a cake having a water content in the range of from about 15% to about 35% by weight. This cake may be mixed with a dispersing agent for the kaolin clay and thereby converted into a fluid slurry, which may be transported and sold in this form. Alternatively, the kaolin clay may be thermally dried, for example, by introducing the fluid slurry of the kaolin clay into a spray drier and thereby transported in a substantially dry form.

According some embodiments, the kaolin described herein may be used as a pigment product in a paper or paperboard product coating as described herein.

According to some embodiments, a coating composition for use in producing coatings on paper or paperboard products and other substrates may include an aqueous suspension of a particulate pigment together with a hydrophilic adhesive or binder, wherein the particulate pigment may include kaolin. For example, the solids content of the paper coating composition may be greater than about 60% by weight, for example, at least about 65%, or as high as possible, but still providing a suitably fluid composition that may be used in coating.

According to some embodiments, the coating composition may include a dispersing agent, for example, up to about 2% by weight of a polyelectrolyte based on the dry weight of pigment present. For example, polyacrylates and copolymers containing polyacrylate units may be used as suitable polyelectrolytes. The kaolin according to some embodiments may be used on its own in the coating composition, or it may be used in conjunction with one or more other known pigments, such as, for example, calcined kaolin, titanium dioxide, calcium sulphate, satin white, talc, and so called “plastic pigment.” When a mixture of pigments is used, the kaolin composition according some embodiments may be present in the mixture of pigments in an amount of at least about 80% of the total dry weight of the mixed pigments.

According to some embodiments, the binder of the coating composition may include an adhesive derived from natural starch obtained from a known plant source, for example, wheat, maize, potato, or tapioca, although it is not essential to use starch as a binder ingredient. Other binders, which may be used with or without starch, are mentioned later.

According to some embodiments, the starch employed as a binder ingredient may be either unmodified or raw starch, or it may be modified by one or more chemical treatments. For example, the starch may be oxidized to convert some of its —CH₂OH groups to —COOH groups. In some cases the starch may have a small proportion of acetyl, —COCH₃, groups. Alternatively, the starch may be chemically treated to render it cationic or amphoteric, in particular, with both cationic and anionic charges. The starch may also be converted to a starch ether or hydroxyalkylated starch by replacing some —OH groups with, for example, —O—CH₂—CH₂OH groups, —O—CH₂—CH₃ groups or —O—CH₂—CH₂—CH₂—OH groups. A further class of chemically treated starches that may be used is the starch phosphates. Alternatively, the raw starch may be hydrolyzed by means of a dilute acid or an enzyme to produce a gum of the dextrin type.

According to some embodiments, the amount of the starch binder used in the coating composition may be from about 4% to about 25% by weight, based on the dry weight of pigment. The starch binder may be used in conjunction with one or more other binders, for example, synthetic binders of the latex or polyvinyl acetate or polyvinyl alcohol type. When the starch binder is used in conjunction with another binder, for example, a synthetic binder, the amount of the starch binder may be from about 2% to about 20% by weight, and the amount of the synthetic binder from about 2% to about 12% by weight, both based on the weight of dry pigment. For example, at least about 50% by weight of the binder mixture includes modified or unmodified starch.

According to some embodiments, a method of use of the coating composition may include applying the coating composition to a sheet of paper or paperboard and calendering the paper or paperboard to form a gloss coating thereon. According to some embodiments, the gloss coating is formed on one or both sides of the paper or paperboard. According to some embodiments, calendering may include passing a coated paper sheet or paperboard between calender nips or rollers one or more times to improve the paper or paperboard smoothness and gloss and reduce the bulk. According to some embodiments, elastomer coated rollers may be employed to give pressing of high solids compositions, and elevated temperature may be applied, and/or five or more passes through the nips may be performed.

According to some embodiments, paper or paperboard after coating and calendering may have a total weight per unit area in the range 30 g/m² to 70 g/m², for example, 49 g/m² to 65 g/m² or 35 g/m² to 48 g/m². The final coating may have a weight per unit area preferably from 3 g/m² to 20 g/m², for example, from 5 g/m² to 13 g/m². Such a coating may be applied to both sides of the paper. According to some embodiments, the paper gloss may be greater than 45 TAPPI units, and the Parker Print Surf value at a pressure of 1 MPa of each paper coating may be less than 1 micron.

The gloss of a coated paper or paperboard surface may be measured by means of a test laid down in TAPPI Standard No 480 ts-65. The intensity of light reflected at an angle from the surface of the paper or paperboard is measured and compared with a standard of known gloss value. The beams of incident and reflected light are both at an angle of 75 degrees to the normal to the surface. The results are expressed in TAPPI gloss units. According to some embodiments, the gloss of the pigment product may be greater than about 50, for example, greater than 55, TAPPI units.

The Parker Print Surf test provides a measure of the smoothness of a paper surface, and includes measuring the rate at which air under pressure leaks from a sample of the coated paper or paperboard which is clamped, under a known standard force, between an upper plate, which incorporates an outlet for the compressed air, and a lower plate, the upper surface of which is covered with a sheet of either a soft or a hard reference supporting material according to the nature of the paper or paperboard being tested. From the rate of escape of the air, a root-mean-square gap in microns between the paper surface and the reference material is calculated. A smaller value of this gap represents a higher degree of smoothness of the surface of the paper being tested.

According to some embodiments, the adhesive or binder of the coating composition may form from 4% to 30%, for example, from 8% to 20% (e.g., from 8% to 15%) by weight of the solids content of the coating composition. The amount employed may depend on the coating composition and the type of adhesive, which may itself incorporate one or more ingredients. For example, hydrophilic adhesives incorporating one or more of the following adhesive or binder ingredients may be used in the following stated amounts: (a) latex: levels ranging from 4% by weight to 20% by weight (the latex may include, for example, a styrene butadiene, acrylic latex, vinyl acetate latex, or styrene acrylic copolymers); and (b) other binders: levels ranging from 4% by weight to 20% by weight. Examples of other binders include casein, polyvinyl alcohol, and polyvinyl acetate.

Additives in various classes may, depending on the type of coating composition and/or material to be coated, be included in the coating composition. Examples of such classes of optional additives are as follows:
(a) cross linkers, for example, in levels up to 5% by weight (e.g., glyoxals, melamine formaldehyde resins, ammonium zirconium carbonates);
(b) water retention aids, for example, in levels up to 2% by weight (e.g., sodium carboxymethyl cellulose, hydroxyethyl cellulose, PVA (polyvinyl acetate), starches, proteins, polyacrylates, gums, alginates, polyacrylamide bentonite, and other commercially available products sold for such applications);
(c) viscosity modifiers or other thickeners, for example, in levels up to 2% by weight (e.g., polyacrylates, emulsion copolymers, dicyanamide, triols, polyoxyethylene ether, urea, sulphated castor oil, polyvinyl pyrrolidone, montmorillonite, sodium alginate, xanthan gum, sodium silicate, acrylic acid copolymers, HMC (hydroxymethyl celluloses), HEC (hydroxyethyl celluloses));
(d) lubricity/calendering aids, for example, in levels up to 2% by weight (e.g., calcium stearate, ammonium stearate, zinc stearate, wax emulsions, waxes, alkyl ketene dimer, glycols);
(e) dispersants, for example, in levels up to 2% by weight (e.g., polyelectrolytes, such as polyacrylates and copolymers containing polyacrylate species, for example, polyacrylate salts (e.g., sodium and aluminum optionally with a Group II metal salt), sodium hexametaphosphates, non-ionic polyol, polyphosphoric acid, condensed sodium phosphate, non-ionic surfactants, alkanolamine, and other reagents commonly used for this function);
(f) antifoamers/defoamers, for example, in levels up to 1% by weight (e.g., blends of surfactants, tributyl phosphate, fatty polyoxyethylene esters plus fatty alcohols, fatty acid soaps, silicone emulsions and other silicone containing compositions, waxes and inorganic particulates in mineral oil, blends of emulsified hydrocarbons, and other compounds sold commercially to carry out this function);
(g) dry or wet pick improvement additives, for example, in levels up to 2% by weight (e.g., melamine resin, polyethylene emulsions, urea formaldehyde, melamine formaldehyde, polyamide, calcium stearate, styrene maleic anhydride, and others);
(h) dry or wet rub improvement and abrasion resistance additives, for example, in levels up to 2% by weight (e.g., glyoxal based resins, oxidized polyethylenes, melamine resins, urea formaldehyde, melamine formaldehyde, polyethylene wax calcium stearate, and others);
(i) gloss-ink hold-out additives, for example, in levels up to 2% by weight (e.g., oxidized polyethylenes, polyethylene emulsions, waxes, casein, guar gum, CMC, HMC, calcium stearate, ammonium stearate, sodium alginate, and others;
(j) optical brightening agents (OBA) and fluorescent whitening agents (FWA), for example, in levels up to 1% by weight (e.g., stilbene derivatives));
(k) dyes, for example, in levels up to 0.5% by weight;
(l) biocides/spoilage control agents, for example, in levels up to 1% by weight (e.g., metaborate, sodium dodecylbenene sulphonate, thiocyanate, organosulphur, sodium benzonate, and other compounds sold commercially for this function, for example, the range of biocide polymers sold by Calgon Corporation);
(m) levelling and evening aids, for example, in levels up to 2% by weight (e.g., non-ionic polyol, polyethylene emulsions, fatty acid, esters, and alcohol derivatives, alcohol/ethylene oxide, sodium CMC, HEC, alginates, calcium stearate, and other compounds sold commercially for this function);
(n) grease- and oil-resistance additives, for example, in levels up to 2% by weight (e.g., oxidized polyethylenes, latex, SMA (styrene maleic anhydride), polyamide, waxes, alginate, protein, CMC, and HMC);
(o) water-resistance additives, for example, in levels up to 2% by weight (e.g., oxidized polyethylenes, ketone resin, anionic latex, polyurethane, SMA, glyoxal, melamine resin, urea formaldehyde, melamine formaldehyde, polyamide, glyoxals, stearates, and other materials commercially available for this function); and
(p) insolubilizer, for example, in levels up to 2% by weight.

For all of the above-listed additives, the percentages by weight provided are based on the dry weight of pigment present in the composition. Where the additive is present in a minimum amount, the minimum amount may be 0.01% by weight based on the dry weight of pigment.

According to some embodiments, the substrates may be coated either on a sheet forming machine (i.e., “on-machine”) or “off-machine” on a coater or coating machine. Use of high solids coating compositions may be desirable because such compositions tend to leave less water to evaporate following the coating process. However, solids levels should not be high enough to create high viscosity and levelling problems.

According to some embodiments, the coating method may include (i) a means of applying the coating composition to the substrate being coated, for example, an applicator; and (ii) a means for ensuring that a desired level of coating composition is applied, for example, a metering device. When an excess of the coating composition is applied to the applicator, the metering device may be provided downstream of the applicator. Alternatively, the correct amount of coating composition may be applied to the applicator by the metering device, for example, as a film press. At the points of coating application and metering, a backing roll (e.g., one or two applicators) or nothing (i.e., web tension) may be used to support the substrate being coated. The time the coating is in contact with the substrate before the excess coating is finally removed (i.e., the dwell time) may be short, long, or variable.

According to some embodiments, the coating composition may be added by a coating head at a coating station. According to the quality of coating desired, the substrate may be single coated, double coated, and triple coated. When providing more than one coat, the initial coat (i.e., a pre-coat) may have a cheaper formulation and optionally less pigment in the coating composition. A coater that is applying a double coating (i.e., a coating on each side of the substrate), may have two or four coating heads, depending on the number of sides coated by each head. Some coating heads coat only one side at a time, but some roll coaters (e.g., film press, gate roll, size press) may coat both sides of the substrate in a single pass.

Examples of coaters that may be employed in step (b) include air knife coaters, blade coaters, rod coaters, bar coaters, multi-head coaters, roll coaters, roll/blade coaters, cast coaters, laboratory coaters, gravure coaters, kiss coaters, liquid application systems, reverse roll coaters, and extrusion coaters.

According to some embodiments of the coating compositions described herein, water may be added to the solids to provide a concentration of solids, which when coated onto a sheet to a desired target coat weight, that has a rheology suitable for the composition to be coated with a pressure (e.g., a blade pressure) of between about 1 and about 1.5 bar. For example, the solids content may be from about 60% to about 70% by weight.

### EXAMPLES

Two samples of the inventive inorganic particulate suspension including a kaolin composition were prepared and tested with the testing results shown in Table 1 below. Samples 1 and 2 were each prepared by blending an example of a fine, blocky kaolin with an example of a hyperplaty kaolin. Sample 1 was blended at a ratio of hyperplaty kaolin-to-blocky kaolin of 90:10, and Sample 2 was blended at a ratio of hyperplaty kaolin-to-blocky kaolin of 80:10. The exemplary kaolin composition samples were thereafter tested to determine characteristics of the kaolin composition samples themselves and characteristics of the inorganic particulate suspensions containing the samples, including brightness, % solids, pH, % residue @ 325 Mesh, shape factor, Brookfield viscosity, Hercules viscosity, and particle size.

TABLE 1

| | | | Fine-Blocky | Hyperplaty | | |
|---|---|---|---|---|---|---|
| | | | Kaolin | Kaolin | Sample 1 | Sample 2 |
| % Solids | | | | 62.4 | 63.6 | 65.6 |
| Shape Factor | | | | 78.4 | 69.9 | 63.1 |
| Visc. Brook. | | | 255 | 312 | 534 | 520 |
| Spindle/RPM | | | 1@20 | 2@20 | 2@20 | 2@20 |
| Hercules @ 4400 | | | | | | |
| RPM @ 18.0 dyne | | | | 369 | 629 | 680 |
| Psd | 10 | um | 100 | 98.5 | 98.7 | 98.7 |
| | 5 | um | 100 | 94.6 | 95.6 | 95.9 |
| | 2 | um | 98 | 76.6 | 79.2 | 81.6 |
| | 1 | um | 94 | 60.4 | 64.1 | 67.7 |
| | 0.5 | um | 84 | 44 | 48.5 | 52.7 |
| | 0.25 | um | 58 | 23.6 | 27.9 | 31.6 |

Table 2 below shows additional data related to Samples 1 and 2.

TABLE 2

Makedown

| | | Sample 1 | Sample 2 |
|---|---|---|---|
| with CMC | % Solids | 64.7 | 66.7 |
| | Visc. | | |
| | Brook. | 464 | 576 |
| | Hercules | 280 | 268 |
| with CMC | % Solids | 64.0 | 65.7 |
| | Visc. | | |
| | Brook. | 350 | 428 |
| | Hercules | 446 | 511 |
| with CMC | % Solids | 63.5 | 65.2 |
| | Visc. | | |
| | Brook. | 292 | 356 |
| | Hercules | 669 | 690 |
| without CMC | % Solids | 63.6 | 65.6 |
| | Visc. | | |
| | Brook. | 304 | 368 |
| | Hercules | 576 | 638 |

As shown by Samples 1 and 2, the addition of the exemplary fine, blocky kaolin to the exemplary hyperplaty kaolin surprisingly results in a kaolin composition for use in inorganic particulate suspensions for use in coating compositions that decreases the high shear viscosity of the inorganic particulate suspensions containing the hyperplaty kaolin composition, as shown by the Hercules viscosity testing results, which may, in turn, decrease the high shear viscosity of a coating composition that includes the inorganic particulate suspension. In addition, the resulting kaolin composition also permits increase of the slurry solids content for the inorganic particulate suspension, which may, in turn, permit increase of the solids content of a coating composition including the inorganic particulate suspension. For example, in the inorganic particulate suspension samples tested the solids content increased about 1% (Sample 1) and 3.2% (Sample 2) relative to an inorganic particulate suspension containing only the hyperplaty kaolin (i.e., without the fine, blocky kaolin) and other non-kaolin solids.

Other embodiments will be apparent to those skilled in the art from consideration of the specification and practice of the embodiments disclosed herein. It is intended that the specification and examples be considered as exemplary only.

1-14. (canceled)

15. An inorganic particulate suspension comprising:
a first kaolin having a shape factor of at least about 70; and
a second kaolin having a shape factor less than or equal to about 20,
wherein the first kaolin and the second kaolin form a kaolin composition,
wherein the kaolin composition has a content ratio of the first kaolin to the second kaolin ranging from about 90:10 to about 50:50, and
wherein the inorganic particulate suspension has a Hercules viscosity ranging from about 600 rpm to about 700 rpm at 18.0 dyne using an “A” bob.

16. The inorganic particulate suspension of claim 15, wherein the inorganic particulate suspension has a Hercules viscosity ranging from about 610 rpm to about 690 rpm at 18.0 dyne using an “A” bob.

17. The inorganic particulate suspension of claim 15, wherein the inorganic particulate suspension has a Hercules viscosity ranging from about 620 rpm to about 685 rpm at 18.0 dyne using an “A” bob.

18. The inorganic particulate suspension of claim 15, wherein the inorganic particulate suspension has a Brookfield viscosity ranging from about 280 cps to about 580 cps using a #2 spindle at 20 rpm.

19. The inorganic particulate suspension of claim 15, wherein the inorganic particulate suspension has a Brookfield viscosity ranging from about 300 cps to about 550 cps using a #2 spindle at 20 rpm.

20. The inorganic particulate suspension of claim 15, wherein the inorganic particulate suspension has a Brookfield viscosity ranging from about 350 cps to about 550 cps using a #2 spindle at 20 rpm.

21. The inorganic particulate suspension of claim 15, wherein the inorganic particulate suspension has a Brookfield viscosity ranging from about 500 cps to about 550 cps using a #2 spindle at 20 rpm.

22-23. (canceled)

24. The inorganic particulate suspension of claim 15, wherein the first kaolin has an average plate diameter ranging from about 2 to about 15.

25-29. (canceled)

30. An inorganic particulate suspension comprising:
a kaolin composition having a shape factor ranging from about 55 to about 75,
wherein at least about 70% to about 90% by weight of the particles of the kaolin composition have a particle size diameter less than 2 microns,
wherein the coating composition has a Hercules viscosity ranging from about 600 rpm to about 700 rpm at 18.0 dyne using an “A” bob, and
wherein the coating composition has a solids content ranging from about 55% to about 75% solids.

31. The inorganic particulate suspension of claim 30, wherein the kaolin composition has a shape factor ranging from about 60 to about 75.

32. The inorganic particulate suspension of claim 30, wherein the kaolin composition has a shape factor ranging from about 63 to about 70.

33. The inorganic particulate suspension of claim 30, wherein at least about 75% to about 85% by weight of the particles of the kaolin composition have an equivalent spherical diameter less than 2 microns.

34. The inorganic particulate suspension of claim 30, wherein at least about 20% to about 40% by weight of the particles of the kaolin composition have a particle size diameter less than 0.25 microns.

35. The inorganic particulate suspension of claim 30, wherein at least about 25% to about 35% by weight of the particles of the kaolin composition have an equivalent spherical diameter less than 0.25 microns.

36. The inorganic particulate suspension of claim 30, wherein the inorganic particulate suspension has a solids content ranging from about 60% to about 75% solids.

37. The inorganic particulate suspension of claim 30, wherein the inorganic particulate suspension has a solids content ranging from about 65% to about 75% solids.

38. The inorganic particulate suspension of claim 30, wherein the inorganic particulate suspension has a solids content ranging from about 65% to about 70% solids.

39. The inorganic particulate suspension of claim 30, wherein the inorganic particulate suspension has a Hercules viscosity ranging from about 610 rpm to about 690 rpm at 18.0 dyne using an “A” bob.

40. The inorganic particulate suspension of claim 30, wherein the inorganic particulate suspension has a Hercules viscosity ranging from about 620 rpm to about 685 rpm at 18.0 dyne using an “A” bob.

41. The inorganic particulate suspension of claim 30, wherein the inorganic particulate suspension has a Brookfield viscosity ranging from about 280 cps to about 580 cps using a #2 spindle at 20 rpm.

42. The inorganic particulate suspension of claim 30, wherein the inorganic particulate suspension has a Brookfield viscosity ranging from about 300 cps to about 550 cps using a #2 spindle at 20 rpm.

43. The inorganic particulate suspension of claim 30, wherein the inorganic particulate suspension has a Brookfield viscosity ranging from about 350 cps to about 550 cps using a #2 spindle at 20 rpm.

44. The inorganic particulate suspension of claim 30, wherein the inorganic particulate suspension has a Brookfield viscosity ranging from about 500 cps to about 550 cps using a #2 spindle at 20 rpm.
